(19) United States
(12) Patent Application Publication
(10) Pub. No.: US 2014/0139312 A1
(43) Pub. Date: May 22, 2014

(54) INSULATION RESISTANT TO DRY BAND ARCING

(71) Applicant: ELECTRO-MOTIVE DIESEL, INC., LaGrange, IL (US)

(72) Inventors: John Ernst Nielsen Madsen, Lemont, IL (US); Edward Joseph Gawel, JR., Woodridge, IL (US)

(73) Assignee: ELECTRO-MOTIVE DIESEL, INC., LaGrange, IL (US)

(21) Appl. No.: 13/680,683

(22) Filed: Nov. 19, 2012

(51) Int. Cl. C08K 3/00; H01F 5/06; B32B 38/08

(52) U.S. Cl. CPC C08K 3/0083; B32B 38/08; H01F 5/06
USPC 336/222; 427/116; 156/280; 523/457

(57) ABSTRACT

A composition for insulating a component may include between about 80 and about 99 percent by volume of a non-silicone-based insulating resin. The composition may also include between about 1 and about 20 percent by volume of magnesia trihydrate.

### TECHNICAL FIELD

This disclosure relates generally to insulation for windings of motors and generators and, more specifically, to an insulation capable of protecting windings in the event a fault exposes the windings to water and/or dirt.

### BACKGROUND

The presence of dirt and water in motors and generators may result in insulation failures. Motors and generators may develop cracks, pinholes, or other faults that allow water and dirt to create a temporary electrically conductive path between the exposed bare windings and its supportive steel structure. With time, the current flow along this conductive path forms a permanent carbon path that is burned into the insulation by dry band arcing, which may cause motor failures. For example, dry band arching may cause excessive current flow to grounded parts of the machine or activate protective circuitry, such as a breaker, to cut off the power supply to the motor. Preventing dry band arcing may extend the time between motor repairs and/or extend the operating life of the motor.

Generally, windings of the motor may include a conductor composed of bare coils, such as, for example, copper coils, that are covered with varnish and layers of insulating film, such as polymide, woven fiberglass, mica, or Teflon. The windings may be impregnated with a material that is resistant to dry band arcing, such as silicon rubber-based elastomeric materials containing a flame retardant additive, for example, alumina trihydrate, to further increase resistance to dry band arcing. However, this additive has a maximum survival temperature of 205° C., well below the expected temperature of 250° C. desired for applications in which the curing and/or operating temperatures are high.

One solution for electrical insulation is described in U.S. Publication No. 2009/0255707 A1 (“the '707 publication”). The publication is directed to a flame-retardant resin composition containing thermoplastic polyurethane elastomer, an ethylene-vinyl acetate copolymer, and optionally a polymer selected from the group consisting of an acid anhydride-modified ethylene-unsaturated carboxylic acid derivative copolymer, an epoxy group-having etheylene-olefin copolymer, and an acid anhydride-modified styrene elastomer. The flame-retardant resin composition may also include a metal hydroxide.

The solution provided by the '707 publication may suffer from a number of possible drawbacks. For example, the viscosity of the composition is too high for use in applications in which it is desirable for the insulation to penetrate tight spaces, such as insulation of motor and/or generator windings. For such applications, in which insulation may use vacuum pressure impregnation or submersion of the winding into the composition in its liquid form, the solution provided by the '707 publication is not practical. Additionally, the '707 publication does not identify which metal hydroxides are suitable for particular applications. For high power applications in which the material may be subject to temperatures exceeding 250° C., alumina trihydrate is not a viable solution, as it breaks down at high temperatures.

The presently disclosed composition and method is directed to overcoming or mitigating one or more of the problems set forth above and/or other problems in the art.

### SUMMARY

According to one aspect, the disclosure is directed to a composition for insulating a component. The composition may include between about 80 and about 99 percent by volume of a non-silicone-based insulating resin. The composition may also include between about 1 and about 20 percent by volume of magnesia trihydrate.

In accordance with another aspect, the disclosure is directed to a method of insulating a substrate. The method may include contacting the substrate with a composition including non-silicone-based insulating resin and magnesia trihydrate. The method may also include applying heat to cure the composition on the substrate.

According to another aspect, the disclosure is directed to a winding. The winding may include a conductive coil and an insulating film at least partially covering the conductive coil. The winding may also include a composition at least partially covering the insulating film, the composition including between about 80 and about 99 percent by volume of a non-silicone-based insulating resin and between about 1 and about 20 percent by volume of magnesia trihydrate.

### BRIEF DESCRIPTION OF THE DRAWINGS

FIG. 1 is a view of an exemplary insulated motor and/or generator winding.

FIG. 2 is a flowchart depicting a exemplary method of insulating a substrate.

### DETAILED DESCRIPTION

Electrical components such as electrical windings, for example those in motors and transformers, are customarily insulated. This may be done by impregnating with a suitable non-silicone-based insulating resin, followed by curing. The coils impregnated with an impregnating resin in this way are more mechanically durable—and conduct the heat better than—unpregnated coils, regardless of whether these coils are wrapped with, for example, an insulating film.

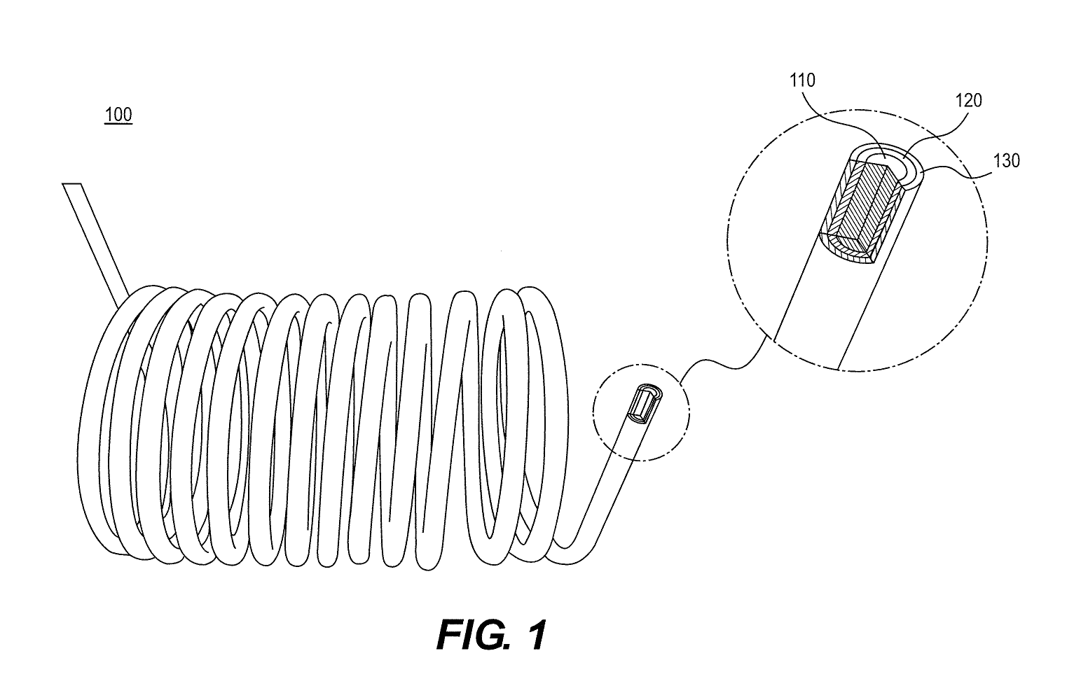

FIG. 1 shows an exemplary insulated motor and/or generator winding 100 including a conductive coil 110. Conductive coil 110 may be made of any conductive or semiconductive material, such as copper. According to some embodiments, coil 110 may be helically fashioned in any manner suitable for use as a winding for a motor and/or generator. For example, coils 110 may overlap and/or interlace with one another. Additionally, coils 110 may be comprised of multiple pieces of material or may be a single piece.

An insulating film 120 may be used to at least partially insulate motor and/or generator winding 100. According to some embodiments, insulating film 120 may be in the form of insulating tape, which may be applied to coils 110 in one or more layers. Insulating film 120 is well known in the art and may be any material suitable for electrical insulation. For example, insulating film 120 may include one or more of polyimide film, woven fiberglass, mica, Teflon, polyamide paper, or Dacron.

A composition 130 may at least partially cover insulating film 120. Composition 130 may seal the insulation system by filling the interstitial space, and like insulating film 120, protect against subsequent entry of dirt and moisture which can cause current flow through contaminants and cause the adjacent insulation to carbonize. Composition 130 may prevent or decrease the likelihood of dry band arcing.

Composition 130 may include between about 80 and about 99 percent by volume of a non-silicone-based insulating resin and between about 1 and about 20 percent by volume of magnesia trihydrate. According to some embodiments, composition 130 may contain between about 1 and about 5 percent by volume of magnesia trihydrate. Optionally, magnesia trihydrate may make up between about 2 and about 4 percent by volume of composition 130. In some embodiments, magnesia trihydrate is about 3 percent by volume of composition 130.

The non-silicone-based insulating resin may be chosen from at least one epoxy, acrylate, polyimide, urethane, vinyl, polyamide, fluoropolymer, acrylic, polyphenylene ether, butadiene, and polyketone.

Epoxy, or epoxide resins, may include compositions based on the epoxide group, a strained three-membered carbon, carbon, oxygen ring structure (also known as the oxirane group). Epoxy resins may include bisephenol A, bisephenol F, bisephenol A/F, modified bisephenol A, and modified bisephoneol A/F liquid epoxy resins. Epoxy may be cured by the addition of a suitable chemical known as a hardener or curing agent. Epoxy, like other non-silicone-based resins, may include additional components such as hardeners, fillers, and binders. Epoxy may be chosen from at least one aliphatic, cycloaliphatic, and aromatic glycidyl ethers.

In embodiments in which the non-silicone-based insulating resin includes cycloaliphatic epoxide and/or aliphatic resins, composition 130 may optionally include high filler loadings. Cycloaliphatic epoxides may include dicyclopentadiene dioxide and/or vinyl cyclohexane dioxide. Aromatic glycidyl ethers may may be used in conjunction with other epoxide resins.

Polyimides may include CP1 and CORIN XLS. Additionally or alternatively, polyimide may include Polyimide Kapton®. Polyimides may include the presence of the phthalimide grouping in the repeat unit. These units may be linked through alkyl or aryl groups to form the main polymer chain, the latter generally giving higher temperature performance.

Non-silicone-based insulating resin may optionally include urethane plastic. Additionaly or alternatively, non-silicone-based insulating resin may include vinyl. For example, non-silicone-based insulating resin may include polyvinyl chloride, polyvinyl alcohol, polyvinyl acetate, and/or polyvinyl fluoride.

Additionally or alternatively, non-silicone-based insulating resin may include one or more polyamides. For example, non-silicione-based insulating resin may include one or more aliphatic polyamides, polyphthalamides, and/or aramides. Some examples of polyamides include nylon Trogamid®, Amodel®, Kevlar®, and Nomex®.

As mentioned, the non-silicone-based insulating resin may be an acrylate. Acrylate polymers may be made from acrylate monomers, include acrylic acid, methyl methacrylate, and acrylonirile. The non-silicone-based insulating resin may also be an acrylic. Non-silicone-based insulating resin may include one or more acrylics, for example, from the polymethylmethacrylate (PMMA) family.

The non-silicone based resin may include one or more fluoropolymers. For example, the resin may include homopolymers or copolymers. According to some embodiments, non-silicone-based resin may include one or more of the following fluoropolymers: etheylene, propylene, vinyl fluoride, tetrafluoretheylene, hexafluoropropylne, perfluoropropylvinylether, perfluoromethylvinylether, and chlorotrifluoroethylene.

Additionally or alternatively, the non-silicone-based insulating resin may include polyphenylene ether, or PPE resins. According to some embodiments, the PPE resin may be a flame retardant grade. Butadiene may also be included in composition 130. It may be polymerized to produce synthetic rubber. It may be in the form of styrene-butadiene or acrylonitrile-butadiene-systrene (ABS). ABS may provide a good surface finish, low water absorption, and good electrical properties. ABS may be a flame retardant grade.

The non-silicone-based insulating may be ketone-based, like polyketone. Additionally or alternatively, the non-silicone-based insulating may be a polyetheretherketone, polyetherketones, or polyetherketoneketones.

Apart from the above-described materials, composition 130 according to the present disclosure may comprise at least one customary and known additive. Examples of suitable additives are defoamers, leveling assistants, wetting agents and corrosion inhibitors. Other suitable additives may include diluents, flexibilizers and plasticizers. The additives may be employed in the customary and known amounts.

Since magnesia trihydrate is a solid material, it may have a tendency to settle out unless composition 130 is mixed or stirred. This may be more likely with non-silicone-based insulators that have lower viscosity. According to some embodiments, magnesia trihydrate may be on the order of nanoparticles to decrease this tendency.

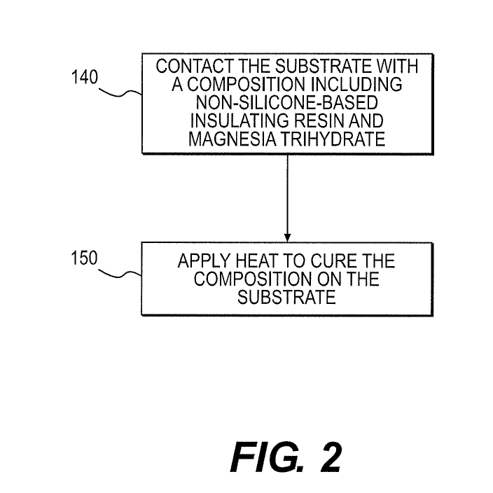

Composition 130 may be applied to conductive coil 110 in a variety of ways, including dipping and vacuum pressure impregnation. FIG. 2 is a flowchart illustrating an exemplary method of insulating a substrate. Step 140 involves contacting a substrate, such as conductive coil 110 of copper configured for use as part of a motor and/or generator, with composition 130. To apply composition 130 by dipping, the substrate is submerged in composition 130. Prior to submersion, conductive coil 110 may be preheated. Additionally or alternatively, composition 130 may be preheated.

A method referred to as “vacuum pressure impregnation” may also be used to contact the substrate, which may be an electrical component such as conductive coil 110, with composition 130. Vacuum pressure impregnation may be done in a cycle of events. Optionally the substrate may be preheated before applying composition 130. The substrate may be placed in a sealed chamber. Then, most of the air is withdrawn from the chamber, creating a vacuum. Then, composition 130 is added to the chamber. Air or another gas, such as nitrogen, flows into the chamber, which is then pressurized to several times atmospheric temperature. This may encourage maximum penetration of composition 130 into crevices and tight spaces of the substrate. For conductive coil 110, this feature may be desired.

Optionally, while composition 130 is in the vacuum chamber, composition 130 may be circulated. Additionally, the vacuum chamber may be equipped with a chilling mechanism to keep composition 130 cool enough so that the varnish does not start to solidify during the impregnation process. This may be particularly desirable for components that are preheated prior to the impregnation process.

Once composition 130 has impregnated the substrate, the substrate is removed. At step 150, heat may be applied to cure composition 130 on the substrate. For example, the substrate may be placed in an oven to cure. The temperature at which composition 130 is cured may vary, depending on, for example, the type of non-silicone-based insulator that is used. It may be desirable to cure composition 130 at a temperature above the expected subsequent operating temperature of the substrate. According to some embodiments, the curing temperature is in the range of 200° C. to 300° C. Additionally or alternatively, the curing temperature may be in the range of 240° C. to 300° C. For example, composition 130 may be cured at 250° C.

### EXAMPLES

The present disclosure will be described more in detail with reference to the following prophetic examples. However, the present disclosure should not be limited to these Examples.

### Example 1

An insulating composition is produced by combining 91% by volume of bisphenol A epoxy resin with 9% by volume of magnesia trihydrate. To encourage even mixture, the particles of magnesia trihydrate are nanoparticles, and the mixture is stirred prior to any use to prevent any settling of the nanoparticles within the epoxy resin.

### Example 2

To insulate a motor and/or generator winding, the winding is placed in a sealed chamber. A vacuum is created within the sealed chamber. The composition of EXAMPLE 1 is added into the sealed chamber. Then, the sealed chamber is pressurized to encourage the composition of EXAMPLE 1 to coat all the surfaces of the motor and/or generator winding. The sealed chamber is depressurized and opened. After the motor and/or generator winding is removed from the sealed chamber, the winding is placed in an oven set to 250° C. until the composition is fully cured onto the substrate.

### INDUSTRIAL APPLICABILITY

The disclosed system and methods provide a robust solution for insulation for electrical devices operated in harsh or wet environments. The disclosed insulation may decrease the wear and tear of electrical components operated in high temperatures and under harsh circumstances by decreasing the likelihood or occurrence of dry band arcing.

The presently disclosed method of insulation may have several advantages. First, by using non-silicone based insulating resins with a low enough viscosity to impregnate electrical components, such as the windings of a motor and/or generator, the compositions can more completely coat the component. This may decrease the risk of damage to the component due to undesired temporary conductivity.

Additionally, by incorporating magnesia trihydrate into the insulation, the disclosed systems and methods can allow the electrical components to operate in temperatures exceeding 200° C. while still decreasing the risk of damage due to dry band arcing.

It will be apparent to those skilled in the art that various modifications and variations can be made to the disclosed compositions and associated methods for using the same. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A composition for insulating a component, comprising:
between about 80 and about 99 percent by volume of a non-silicone-based insulating resin; and
between about 1 and about 20 percent by volume of magnesia trihydrate.

2. The composition of claim 1, wherein the non-silicone-based insulating resin is chosen from at least one epoxy, acrylate, polyimide, urethane, vinyl, polyamide, fluoropolymer, acrylic, polyphenylene ether, butadiene, and polyketone.

3. The composition of claim 1, wherein the amount of magnesia trihydrate by volume is between about 1 and about 10 percent.

4. The composition of claim 3, wherein the composition includes about 3 percent by volume of magnesia trihydrate.

5. The composition of claim 2, wherein the non-silicone-based insulating resin is an epoxy and the epoxy is chosen from at least one aliphatic, cycloaliphatic, and aromatic glycidyl ethers.

6. A method of insulating a substrate, comprising:
contacting the substrate with a composition including non-silicone-based insulating resin and magnesia trihydrate; and
applying heat to cure the composition on the substrate.

7. The method of claim 6, wherein the non-silicone-based insulating resin is chosen from at least one epoxy, acrylate, polyimide, urethane, vinyl, polyamide, fluoropolymer, acrylic, polyphenyline ether resin, polyketone, and butadiene.

8. The method of claim 6, further including applying at least one layer of insulating film to the substrate, wherein the insulating film is comprised of at least one of the following materials: mica, polyimide film, polyamide paper, woven fiberglass, Mylar, or Dacron.

9. The method of claim 6, wherein the composition includes less than 10 percent by volume of magnesia trihydrate.

10. The method of claim 7, wherein the non-silicone-based insulating resin is an epoxy and the epoxy is chosen from at least one aliphatic, cycloaliphatic, and aromatic glycidyl ethers.

11. The method of claim 6, wherein contacting the substrate with the composition includes submerging the substrate in the composition.

12. The method of claim 6, wherein contacting the substrate with the composition includes:
placing the substrate in a sealed chamber;
creating a vacuum within the sealed chamber;
adding the composition into the sealed chamber; and
pressurizing the sealed chamber to encourage the composition to coat the substrate.

13. The method of claim 12, wherein the substrate is a copper winding configured for use as part of a motor and/or generator.

14. The method of claim 12, wherein the heat applied to cure the composition is between 240° C. and 300° C.

15. A winding, comprising:
a conductive coil;
an insulating film at least partially covering the conductive coil; and
a composition at least partially covering the insulating film, the composition including:
between about 80 and about 99 percent by volume of a non-silicone-based insulating resin; and
between about 1 and about 20 percent by volume of magnesia trihydrate.

16. The winding of claim 15, wherein the insulating film includes at least one of polyimide film, woven fiberglass, mica, Teflon, polyamide paper, or Dacron.

17. The winding of claim 15, the non-silicone-based insulating resin is chosen from at least one epoxy, acrylate, polyimide, urethane, vinyl, polyamide, fluoropolymer, acrylic, polyphenylene ether, and polyketone

18. The winding of claim 17, wherein the non-silicone-based insulating resin is an epoxy chosen from at least one aliphatic, cycloaliphatic, and aromatic glycidyl ethers.

19. The winding of claim 15, wherein the composition includes between 1 and 5 percent by volume of magnesia trihydrate.

20. The winding of claim 15, wherein the composition includes 3 percent by volume of magnesia trihydrate.
